(19) United States
(12) Patent Application Publication
(10) Pub. No.: US 2009/0191307 A1
(43) Pub. Date: Jul. 30, 2009

(54) COMPOSITIONS FOR FEEDING ANIMALS

(76) Inventors: DAVID HOLZGRAEFE, Quincy, IL (US); HONG YANG, Peoria, IL (US)

Correspondence Address: ARCHER DANIELS MIDLAND COMPANY, 4666 FARIES PARKWAY, DECATUR, IL, 62526, US

(21) Appl. No.: 12/360,354

(22) Filed: Jan. 27, 2009

Related U.S. Application Data
(60) Provisional application No. 61/023,909, filed on Jan. 28, 2008.

(51) Int. Cl. A23K 1/14

(52) U.S. Cl. 426/2; 426/623; 426/72; 426/661

(57) ABSTRACT

Feed compositions comprising modified starches and an animal feed ingredient are disclosed, as well as methods of feeding such compositions to animals.

### CROSS-REFERENCE TO RELATED APPLICATION(S)

This application claims the benefit of U.S. Provisional Application No. 61/023,909, filed Jan. 28, 2008, the contents of the entirety of which are incorporated by this reference

### TECHNICAL FIELD

The present invention relates generally to animal feed compositions as well as methods for feeding such animal feed compositions to animals.

### SUMMARY OF THE INVENTION

In one embodiment, a dry feed composition comprises an ingredient selected from the group consisting of maltodextrin, dextrose and a combination thereof, and a grain product.

In another embodiment, a method comprises feeding an animal feed composition comprising maltodextrin to a monogastric animal such that the monogastric animal receives an amount of the malotdextrin of between 0.001-10% of the monogastric animal's weight per day.

In yet a further embodiment, a feed composition comprises dextrose, maltodextrin, corn syrup solids, starch, dextrin and sucrose, wherein the feed composition comprises at least 15% total sugars.

### DESCRIPTION OF THE DRAWINGS

FIGS. 1-5 represent performance characteristics of various embodiments of feed compositions of the present invention.

### DESCRIPTION OF THE INVENTION

A successful nursery feeding program is designed to optimize performance and maximize profitability of the nursery and subsequent grow-finish stages. Digestive systems of weanling pigs are not well developed. Consequently, a complex diet with highly digestible energy and other ingredients is needed. Milk ingredients and crystalline lactose are often used as highly digestible energy (lactose) sources in early nursery diets.

Dietary carbohydrates are broken down by specific enzymes in the gastro-intestinal tract to provide energy for newly weaned pigs. The enzymes involved in digestion of carbohydrates are lactase, amylase, trehalase, four maltases (sucrase, isomaltase, maltase II and maltase III), and possibly dextrinase, if present in the animals. Lactase breaks down lactose whereas amylase breaks down starch.

Activity of the enzymes involved in digestion of starch and other carbohydrates (amylase, maltases, trehalase and dextrinase) is lower before and shortly after weaning than that of the lactose enzyme lactase. As a result, diets provided to early-weaned pigs typically contain a source of lactose (either through milk products or crystalline lactose). Milk ingredients are expensive, leading for a search for other carbohydrates, which may not be quite as digestible as lactose, but more digestible than the starch contained in corn, oat or other feed ingredients.

Maltodextrin is a nonsweet, easily digested carbohydrate which is often used in food grade products such as, for example, nutritional beverages for humans. Maltodextrin may be made from cornstarch or other starches. The maltodextrin may be produced by cooking the starch, and adding acid and/or enzymes that break the starch into smaller chains. Maltodextrin often contains 3-20 dextrose molecules which include several dextrose molecules held together by weak, hydrogen bonds. These bonds are broken down by enzymes in the gastro-intestinal tract. Maltodextrin can be broken down to yield glucose by amylase and dextrinase. Isomaltase, maltase II and III may also be involved in digestion of maltodextrin.

Maltodextrin has a dextrose equivalent (DE) of less than 20 according to the AAFCO (American Association of Feed Control Official) definition. Dextrose equivalent is a measure of reducing power as compared to a dextrose standard of 100. On a 1 to 100 scale, pure dextrose has a value of 100 and starch has a value of close to 1. The higher the dextrose equivalent, the greater the extent of starch depolymerization, resulting in a smaller average polymer size. Commercially available maltodextrin products typically have a dextrose equivalent of 5, 10, 15or18.

Since the enzymes secreted by an animal change after weaning, changing carbohydrate sources in a diet of the animal after weaning may prove beneficial. Thus, as lactase activity decreases after weaning whereas other carbohydrases increase, in one embodiment, maltodextrin is used as a rapidly available energy source that may be used to feed newly weaned animals or adult animals during lactation.

In another embodiment, a modified starch may be used alone or in combination with the maltodextrin in an animal feed composition. The modified starch may comprise a starch that has been treated with heat, acid, enzymes or combinations of any thereof in order to produce oligosaccharide chains. The modified starch includes oligosaccharide chains that are reduced in length or smaller than the oligosaccharide chains present in the non-modified starch. A composition including the modified starch may also include free sugars produced from the treatment of the starch.

In one embodiment, the animals are pigs. In other embodiments, the animals may be poultry, ruminants or young ruminants (i.e., functionally monogastric). In yet a further embodiment, the feed compositions of the present invention may be used in aquaculture such as, for example, fish feed. In still a further embodiment, the animal feed compositions of the present invention may be fed to stressed animals including, but not limited to, heat stressed animals, animals subject to scour outbreaks, animals that have been transported or animals that have been subjected to any other stress event.

In another embodiment, the maltodextrin may be combined with dextrose to produce a mixture having utility as an animal feed. This mixture of maltodextrin and dextrose helps reduce osmolarity as compared to dextrose by itself. Dextrose is the generic term for glucose monohydrate as compared to anhydrous dextrose or pure glucose, which is typically more expensive.

In one embodiment, a combination of maltodextrin and dextrose in the animal feed results in faster nutrient (energy) uptake and water absorption in the gastrointestinal tract as compared to animal feeds that comprise only dextrose. The higher the osmolarity of gut digesta fluid is, the less water that is absorbed into the body which may lead to dehydration. Thus, water will flow faster from the plasma to the gastrointestinal tract with dextrose in the feed as compared to a feed including the combination of dextrose and maltodextrin, which has a lower osmolarity. This combination also provides better energy, nitrogen digestion, better growth performance, better feed efficiency, better lactation performance and/or alleviation of animal water dehydration as compared to dextrose alone.

In another embodiment, maltodextrin, alone or in combination with dextrose, may be used to at least partially replace a lactose source(s) in an animal's diet. This may be especially useful in times when prices for the lactose source, such as milk and/or milk products, has increased as the cost of the animal feeds using such milk and/or milk products may become cost prohibitive.

In other embodiments, the maltodextrin, alone or in combination with dextrose, may be used as a feed for lactating sows, newly weaned pigs, poultry (in turkey feed withdrawal periods and beyond) or any other desired application where an energy source is needed.

In another embodiment, the maltodextrin, alone or in combination with dextrose, may be used to help alleviate animal water dehydration. Dehydration is caused by inadequate water intake, either due to inadequate water supply, long distance transportation, disease or heat stress.

In yet a further embodiment, an animal feed including maltodextrin, alone or in combination with dextrose, may further include a lactose source.

In one embodiment, the combination of dextrose and maltodextrin may be present in an animal feed in an amount between about 2-15% by weight. In other embodiments, the combination of dextrose and maltodextrin may be present in an animal feed composition in an amount between about 5-15% in a prestarter diet, or in an amount between about 2-10% in a starter diet.

In yet another embodiment, a feed composition of the present invention may include functional additives that may modify gut health. Such functional additives include, but are not limited to: a yeast product comprising mannanoligosaccharides, beta-glucan or a combination thereof; prebiotics; inorganic acidifiers; organic acidifiers and combinations of any thereof.

In another embodiment, a feed composition of the present invention may include, without limitation, crystalline amino acids, protein ingredients, and combinations of any thereof.

In yet a further embodiment, a feed composition may include an isolated, purified or synthesized botanical product. Botanical products having utility include, but are not limited to, capsaicin containing products, eugenol containing products, cinnamaldehyde containing products, and combinations of any thereof.

In one embodiment, a feed composition of the present invention may include, but are not limited to, mycotoxin detoxifiers, which may be enzymes or other compounds.

In an additional embodiment, an animal feed composition of the present invention is formulated to be used as inclusion in an animal's diet. For instance, the animal feed composition may be placed into a container such that a user of the animal feed composition may mix the animal feed composition of the present invention with the diet of an animal. In this manner, the animal feed composition of the present invention may be used as an inclusion to the diet, such as in an amount ranging between 1-8%.

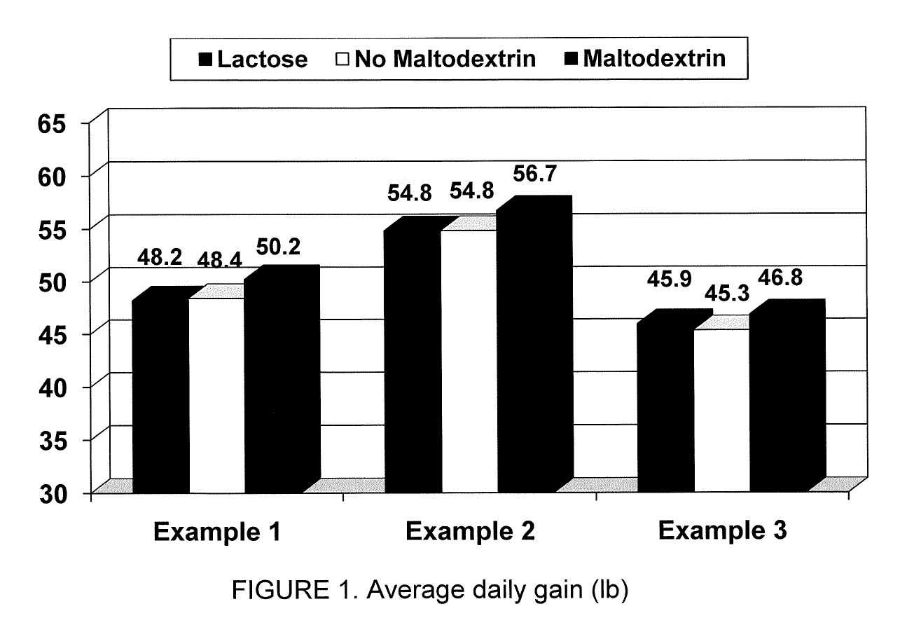

The effect of various animal feed compositions of the present invention on nursery exit weight in pounds (lbs) for pigs is shown in FIG. 1. As illustrated in FIG. 1, various diets of the present invention including maltodextrin increased nursery exit weight of pigs as compared with diets containing no maltodextrin.

The following non-limiting examples are provided to further describe the invention. Those of ordinary skill in the art will appreciate that several variations of these Examples are possible within the spirit of the invention.

### EXAMPLES

### Example 1

Feed compositions having the ingredients listed in Tables 1 and 2 were prepared. Table 1 lists five dietary treatments including a positive control (PC), negative control (NC), a negative control with 2% maltodextrin, a negative control with 4% maltodextrin and a negative control with 6% maltodextrin. The maltodextrin used in this example had a dextrose equivalent of 18. The positive control diets were slightly modified MOMENTUM brand feeding program 10-15 and 15-25, and the negative control diets had 25% less lactose than the positive control diets. MOMENTUM brand feeding programs are available from ADM Alliance Nutrition of Quincy, Ill. The lower lactose levels in the negative control diets were achieved with whey rather than whey permeate or dextrose. Treatments 2-5 had the same levels of whey, whey permeate and dextrose within each phase, but their levels of lactose (sugar) increased as maltodextrin inclusion levels increased. In treatments 3-5, the maltodextrin and dextrose ratios varied from 0.8 to 2.5. Dietary energy, protein, lysine (amino acid ratios), major minerals and vitamins were approximately equal across each treatment within each phase.

TABLE 1
Composition of Stage 1 Diets.

| | Treatment | | | | |
|---|---|---|---|---|---|
| | 1 | 2 | 3 | 4 | 5 |
| | Treatment Description | | | | |
| | Positive | Negative | NC + | NC + | NC + |
| | Control | Control | Maltodextrin | Maltodextrin | Maltodextrin |
| | Maltodextrin DE18, % | | | | |
| | 0 | 0 | 2 | 4 | 6 |
| Ingredients, % | | | | | |
| Grain products | 42.34 | 46.84 | 44.84 | 42.80 | 40.80 |
| Plant protein | 25.00 | 25.00 | 25.00 | 25.00 | 25.00 |
| Animal protein | 21.61 | 17.51 | 17.51 | 17.51 | 17.51 |
| Animal fat | 3.75 | 3.75 | 3.75 | 3.75 | 3.75 |
| Others | 4.90 | 4.50 | 4.50 | 4.54 | 4.54 |
| Dextrose | 2.40 | 2.40 | 2.40 | 2.40 | 2.40 |
| Maltodextrin DE18 | — | — | 2.00 | 4.00 | 6.00 |
| Total | 100.00 | 100.00 | 100.00 | 100.00 | 100.00 |
| Calculated Nutrient Analysis | | | | | |
| Protein, % | 23.68 | 23.59 | 23.44 | 23.29 | 23.14 |
| Fat; Crude, % | 6.75 | 6.75 | 6.78 | 6.76 | 6.80 |
| Dry Matter, % | 90.46 | 90.19 | 90.34 | 90.48 | 90.62 |
| Calcium, % | 1.01 | 1.02 | 1.02 | 1.02 | 1.00 |
| Phosphorus, % | 0.76 | 0.76 | 0.75 | 0.76 | 0.75 |
| Lysine, % | 1.50 | 1.50 | 1.50 | 1.50 | 1.50 |

TABLE 2
Composition of Stage 2, 3 & 4 Diets.

| | Treatment | | | | | |
|---|---|---|---|---|---|---|
| | 1 | 2 | 3 | 4 | 5 | 1-5 |
| | Treatment Description | | | | | |
| | Positive | Negative | NC + 2% | NC + 4% | NC + 6% | Common |
| | Control | Control | Maltodextrin | Maltodextrin | Maltodextrin | Diet |
| | Stage | | | | | |
| | 2 & 3 | 2 & 3 | 2 & 3 | 2 & 3 | 2 & 3 | 4 |
| Ingredients, % | | | | | | |
| Grain Products | 44.01 | 46.30 | 43.86 | 41.37 | 38.88 | 51.22 |
| Plant Protein | 32.55 | 32.65 | 33.05 | 33.45 | 33.85 | 33.75 |
| Animal Protein | 8.46 | 5.89 | 5.89 | 5.89 | 5.89 | 0.50 |
| Grain By Products | 4.00 | 4.00 | 4.00 | 4.00 | 4.00 | 3.00 |
| Animal Fat | 3.15 | 3.15 | 3.20 | 3.30 | 3.40 | 4.20 |
| Dextrose | 2.50 | 2.50 | 2.50 | 2.50 | 2.50 | — |
| Other | 5.33 | 5.51 | 5.50 | 5.49 | 5.48 | 4.83 |
| Roughage | — | — | — | — | — | 2.50 |
| Maltodextrin DE18 | — | — | 2.00 | 4.00 | 6.00 | — |
| Total | 100.00 | 100.00 | 100.00 | 100.00 | 100.00 | 100.00 |
| Calculated Nutrient Analysis | | | | | | |
| Protein, % | 22.01 | 22.00 | 22.00 | 22.00 | 22.01 | 21.00 |
| Fat; Crude, % | 5.28 | 5.27 | 5.25 | 5.27 | 5.30 | 6.29 |
| Dry Matter, % | 89.61 | 89.43 | 89.57 | 89.71 | 89.86 | 89.10 |
| Calcium, % | 0.96 | 0.96 | 0.97 | 0.97 | 0.97 | 0.91 |
| Phosphorus, % | 0.74 | 0.73 | 0.73 | 0.73 | 0.72 | 0.71 |
| Lysine, % | 1.40 | 1.40 | 1.40 | 1.40 | 1.40 | 1.30 |

A total of 175 pigs (Monsanto Choice Genetics, EB×GP37) with an initial weight of 4.91 kilograms were used to assess the ability of maltodextrin with a dextrose equivalent of 18 to be an energy source. The pigs were allotted to one of five treatments based on their initial weight and ancestry.

There were 4 phases (stages) with 6, 7, 8 and 15 days, respectively. In the phase with 15 days, all pigs were fed a common meal diet using MOMENTUM brand feeding program 25-50 formulation. All pigs were transported four hours before the example started at weaning.

Results from this example are presented in Table 3. Compared to pigs fed negative control diets, the pigs fed the positive control diets had similar daily gain and similar feed intake (P>0.10) throughout the example, except phase 2. In phase 2, pigs fed the positive control diets consumed more feed than pigs fed the negative control diets (P<0.10), which led to a poorer feed efficiency for pigs fed positive control diets in phase 2. For cumulative phases 1-3, feed efficiency was better for pigs fed negative control diets as compared to pigs fed positive control diets. This suggests that pigs fed 25% more lactose (i.e., the positive control diet) did not perform better than pigs fed 25% less lactose (i.e., the negative control diet). In this example, the higher lactose diets had a negative effect on feed efficiency which is opposite than what would be expected.

TABLE 3
Evaluation of Maltodextrin DE18 as an Energy (Lactose)
Source in Swine Nursery Diets Performance Data.

| Treatment No. | | | | | |
|---|---|---|---|---|---|
| 1 | 2 | 3 | 4 | 5 | |
| Treatment Description | | | | | |
| Positive | Negative | Negative | Negative | Negative | |
| Control | Control | Control | Control | Control | P Values |

| | Maltodextrin, % | | | | | | | Pair-wise | | Maltodextrin | | |
|---|---|---|---|---|---|---|---|---|---|---|---|---|
| | 0 | 0 | 2 | 4 | 6 | Mean | SE | Comparison¹ | Program | Linear | Quadratic | Cubic |
| No. pens/trt | 7 | 7 | 7 | 7 | 7 | | | | | | | |
| No. pigs/trt | 35(1)* | 35 | 35(3) | 35 | 35(4) | | | | | | | |
| Weight, kg | | | | | | | | | | | | |
| Initial | 4.91 | 4.90 | 4.90 | 4.91 | 4.91 | 4.91 | 0.28 | | | | | |
| Stage 1, 6 d | 5.66 | 5.55 | 5.51 | 5.72 | 5.68 | 5.62 | 0.08 | h | 0.324 | 0.102 | 0.979 | 0.188 |
| Stage 2, 7 d | 7.85 | 7.76 | 7.84 | 7.89 | 8.08 | 7.88 | 0.15 | — | 0.606 | 0.126 | 0.708 | 0.811 |
| Stage 3, 8 d | 11.69 | 11.84 | 11.67 | 11.75 | 11.95 | 11.78 | 0.20 | — | 0.853 | 0.642 | 0.367 | 0.887 |
| Stage 4, 15 d | 21.84 | 21.95 | 22.53 | 22.44 | 22.79 | 22.31 | 0.48 | — | 0.596 | 0.265 | 0.812 | 0.604 |
| Daily Gain, | | | | | | | | | | | | |
| kg | | | | | | | | | | | | |
| Stage 1, 6 d | 0.125 | 0.108 | 0.101 | 0.135 | 0.129 | 0.119 | 0.014 | h | 0.370 | 0.118 | 0.965 | 0.209 |
| Stage 2, 7 d | 0.309 | 0.316 | 0.321 | 0.311 | 0.331 | 0.317 | 0.013 | — | 0.759 | 0.538 | 0.559 | 0.450 |
| Stage 3, 8 d | 0.480 | 0.510 | 0.467 | 0.482 | 0.464 | 0.481 | 0.020 | — | 0.530 | 0.189 | 0.542 | 0.318 |
| Stage 4, 15 d | 0.677 | 0.674 | 0.724 | 0.712 | 0.718 | 0.701 | 0.026 | — | 0.515 | 0.311 | 0.398 | 0.505 |
| Overall, S1-2 | 0.222 | 0.220 | 0.216 | 0.230 | 0.235 | 0.224 | 0.010 | — | 0.686 | 0.207 | 0.654 | 0.566 |
| Overall, S1-3 | 0.320 | 0.330 | 0.308 | 0.326 | 0.320 | 0.321 | 0.011 | — | 0.709 | 0.816 | 0.469 | 0.226 |
| Overall, S1-4 | 0.468 | 0.473 | 0.477 | 0.487 | 0.480 | 0.477 | 0.015 | — | 0.919 | 0.660 | 0.714 | 0.731 |
| Feed Intake, kg/d | | | | | | | | | | | | |
| Stage 1, 6 d | 0.161 | 0.154 | 0.147 | 0.162 | 0.162 | 0.157 | 0.011 | — | 0.812 | 0.418 | 0.763 | 0.429 |
| Stage 2, 7 d | 0.404 | 0.372 | 0.392 | 0.390 | 0.393 | 0.390 | 0.013 | a | 0.539 | 0.302 | 0.522 | 0.663 |
| Stage 3, 8 d | 0.632 | 0.635 | 0.631 | 0.643 | 0.630 | 0.634 | 0.014 | — | 0.965 | 0.973 | 0.777 | 0.508 |
| Stage 4, 15 d | 0.937 | 0.943 | 0.960 | 0.987 | 0.944 | 0.954 | 0.025 | — | 0.607 | 0.786 | 0.231 | 0.471 |
| Overall, S1-2 | 0.290 | 0.272 | 0.274 | 0.285 | 0.283 | 0.281 | 0.010 | — | 0.679 | 0.322 | 0.804 | 0.641 |
| Overall, S1-3 | 0.419 | 0.410 | 0.405 | 0.422 | 0.412 | 0.413 | 0.010 | — | 0.789 | 0.638 | 0.834 | 0.307 |
| Overall, S1-4 | 0.634 | 0.632 | 0.631 | 0.657 | 0.626 | 0.636 | 0.014 | — | 0.567 | 0.924 | 0.292 | 0.192 |
| Feed/Gain | | | | | | | | | | | | |
| Stage 1, 6 d | 1.334 | 1.448 | 1.780 | 1.213 | 1.334 | 1.422 | 0.194 | H | 0.316 | 0.306 | 0.592 | 0.079 |
| Stage 2, 7 d | 1.319 | 1.192 | 1.224 | 1.259 | 1.190 | 1.237 | 0.034 | AbD | 0.069 | 0.854 | 0.150 | 0.498 |
| Stage 3, 8 d | 1.328 | 1.247 | 1.357 | 1.337 | 1.386 | 1.331 | 0.045 | eG | 0.291 | 0.062 | 0.509 | 0.332 |
| Stage 4, 15 d | 1.417 | 1.400 | 1.325 | 1.388 | 1.320 | 1.370 | 0.041 | d | 0.337 | 0.339 | 0.936 | 0.154 |
| Overall, S1-2 | 1.305 | 1.242 | 1.278 | 1.245 | 1.215 | 1.257 | 0.029 | D | 0.241 | 0.391 | 0.267 | 0.578 |
| Overall, S1-3 | 1.314 | 1.242 | 1.321 | 1.294 | 1.295 | 1.293 | 0.030 | ae | 0.396 | 0.330 | 0.211 | 0.328 |
| Overall, S1-4 | 1.364 | 1.336 | 1.323 | 1.350 | 1.307 | 1.336 | 0.024 | d | 0.511 | 0.574 | 0.545 | 0.328 |

*Numbers in parentheses are numbers of pigs removed during the trial.
¹A lower case letter refers to .05 < P < .10 and an upper case letter refers to P < .05.
A or a = Trt 1 vs. Trt 2
B or b = Trt 1 vs. Trt 3
C or c = Trt 1 vs. Trt 4
D or d = Trt 1 vs. Trt 5
E or e = Trt 2 vs. Trt 3
F or f = Trt 2 vs. Trt 4
G or g = Trt 2 vs. Trt 5
H or h = Trt 3 vs. Trt 4
I or i = Trt 3 vs. Trt 5
J or j = Trt 4 vs. Trt 5

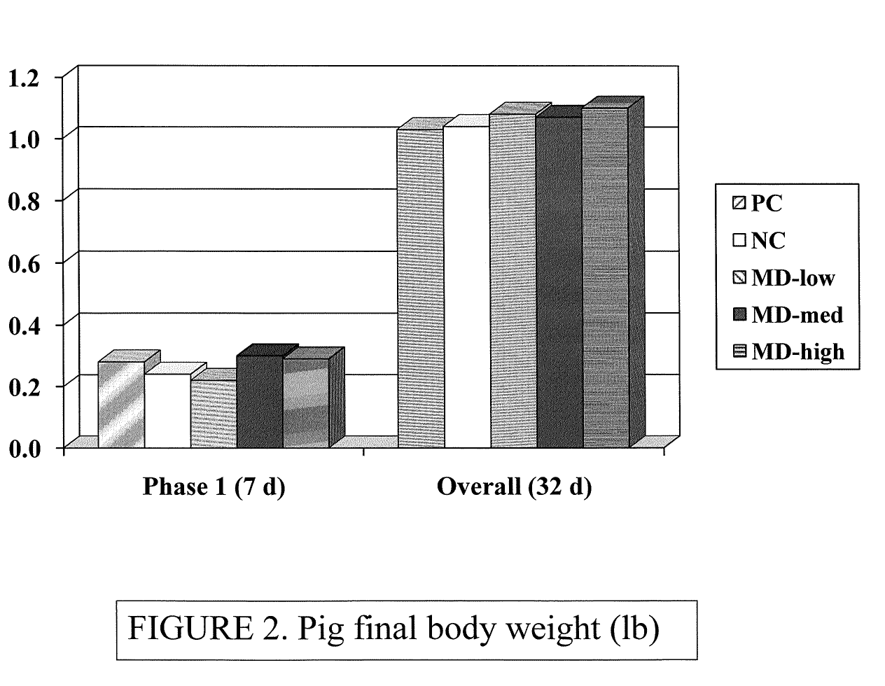

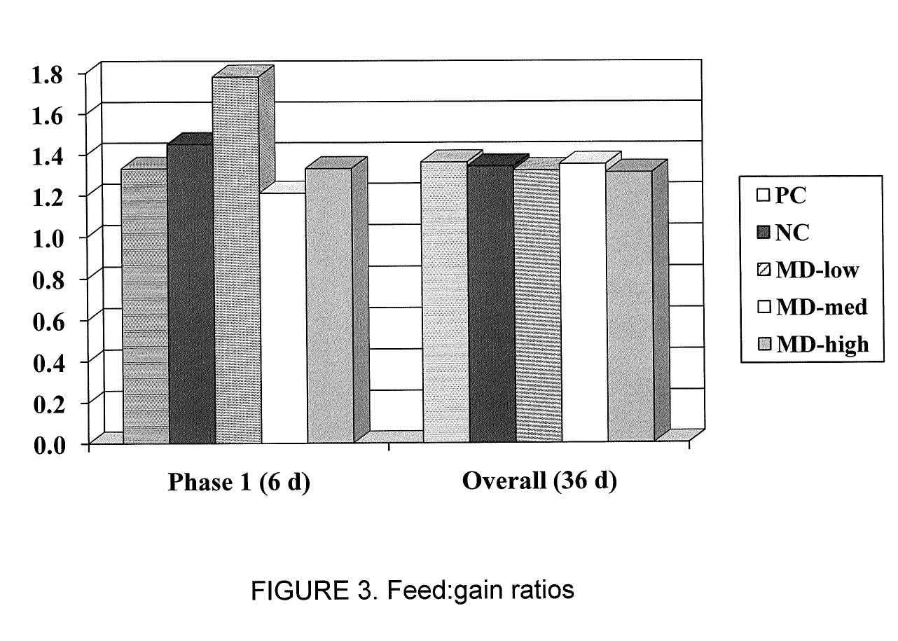

FIG. 2 shows the effects of maltodextrin (MD) levels on average daily gain (ADG) of pigs fed the diet compositions of this example. FIG. 3 shows the effects of maltodextrin (MD) levels on the feed/gain (F/G) of pigs fed the diet compositions of this example. There were 7 pens and 35 pigs per treatment with a weaning weight of 10.8 lbs. Phases 1, 2 and 3 correlate to 6, 15 and 15 days, respectively. The positive control diets had 3% and 1.9% units more lactose than the negative control diets in phases 1 and 2. In phase 1, the average daily gain had a P value of 0.12 for the maltodextrin linear effect, and the feed/gain had a P value of 0.08 for the maltodextrin cubic effect.

This example also indicates that increasing dietary inclusion levels of maltodextrin tended to linearly improve daily gain in phase 1 (P=0.1 18), which led to a linear improvement of body weight at the end of 6-day phase 1 (P=0.102). Maltodextrin levels also had a cubic effect on feed efficiency in phase 1 (P=0.079), with 4% maltodextrin improving feed efficiency. This indicates that maltodextrin is a highly available energy source for early weaning pigs.

In phase 3, increasing dietary maltodextrin had a negative linear effect on feed efficiency (P=0.062). The maltodextrin had no significant effects on overall daily gain, feed intake, or feed efficiency (P>0.20). The lack of overall performance response to maltodextrin was not surprising since there was no positive performance response from increasing dietary lactose by 25% in this example.

Data from this example suggests that increasing dietary lactose improved daily gain by 16% and feed efficiency by 7.9% in the first 6 days post-weaning, although overall performance was not improved. This may suggest that the negative control diets had adequate lactose levels for nursery pigs after the first 6 days of the example. The data further suggests that increasing dietary maltodextrin (i.e., increasing maltodextrin to dextrose ratios) was beneficial to early weaning pigs by improving daily gain during the first 6 days post-weaning. Further, the diets including 4% maltodextrin improved feed efficiency by 16% in the first 6 days post-weaning. Also, the addition of 2-6% maltodextrin in the diets numerically increased final body weight by 0.49 to 0.84 kg per pig. This additional weight gain gleaned from the use of maltodextrin can help swine producers in getting heavier pigs, as well as being able to at least partially replace an expensive lactose source with a more economical maltodextrin source.

### Example 2

Feed compositions having the ingredients listed in Tables 4 and 5 were prepared. Table 5 lists five dietary treatments including a positive control (PC), negative control (NC), a negative control with 2% maltodextrin, a negative control with 4% maltodextrin and a negative control with 6% maltodextrin. The maltodextrin in this example had a dextrose equivalent of 18. The positive control diets were slightly modified MOMENTUM brand feeding program 10-15 and 15-25, and the negative control diets had 25% less lactose than the positive control diets. The lower lactose levels in the negative control diets were achieved with whey rather than whey permeate or dextrose. Treatments 2-5 had the same levels of whey, whey permeate and dextrose within each phase, but their levels of lactose (sugar) increased as maltodextrin inclusion levels increased. In treatments 3-5, the maltodextrin and dextrose ratios varied from 0.8 to 2.5. Maltodextrin with a dextrose equivalent of 18 was added to the negative control diets at the expense of corn. Dietary energy, protein, lysine (amino acid ratios), major minerals and vitamins were approximately equal across each treatment within each phase.

TABLE 4
Composition of Stage 1 & 2 Diets.

| | Treatment | | | | |
|---|---|---|---|---|---|
| | 1 | 2 | 3 | 4 | 5 |
| | Treatment Description | | | | |
| | Positive | Negative | NC + | NC + | NC + |
| | Control | Control | Maltodextrin | Maltodextrin | Maltodextrin |
| | Maltodextrin DE18, % | | | | |
| | 0 | 0 | 2 | 4 | 6 |
| Ingredients, % | | | | | |
| Grain Products | 42.34 | 46.84 | 44.84 | 42.80 | 40.80 |
| Plant Protein | 25.00 | 25.00 | 25.00 | 25.00 | 25.00 |
| Animal Protein | 21.61 | 17.51 | 17.51 | 17.51 | 17.51 |
| Animal Fat | 3.75 | 3.75 | 3.75 | 3.75 | 3.75 |
| Others | 4.90 | 4.50 | 4.50 | 4.54 | 4.54 |
| Dextrose | 2.40 | 2.40 | 2.40 | 2.40 | 2.40 |
| Maltodextrin DE18 | — | — | 2.00 | 4.00 | 6.00 |
| Total | 100.00 | 100.00 | 100.00 | 100.00 | 100.00 |
| Calculated Nutrient Analysis | | | | | |
| Protein, % | 23.68 | 23.59 | 23.44 | 23.29 | 23.14 |
| Fat; Crude, % | 6.75 | 6.75 | 6.78 | 6.76 | 6.80 |
| Dry Matter, % | 90.46 | 90.19 | 90.34 | 90.48 | 90.62 |
| Calcium, % | 1.01 | 1.02 | 1.02 | 1.02 | 1.00 |
| Phosphorus, % | 0.76 | 0.76 | 0.75 | 0.76 | 0.75 |
| Lysine, % | 1.50 | 1.50 | 1.50 | 1.50 | 1.50 |

TABLE 5
Composition of Stage 3 & 4 Diets.

| | Treatment | | | | | |
|---|---|---|---|---|---|---|
| | 1 | 2 | 3 | 4 | 5 | 1-5 |
| | Treatment Description | | | | | |
| | Positive | Negative | NC + 2% | NC + 4% | NC + 6% | Common |
| | Control | Control | Maltodextrin | Maltodextrin | Maltodextrin | Diet |
| | Stage | | | | | |
| | 3 | 3 | 3 | 3 | 3 | 4 |
| Ingredients, % | | | | | | |
| Grain Products | 44.01 | 46.30 | 43.86 | 41.37 | 38.88 | 51.22 |
| Plant Protein | 32.55 | 32.65 | 33.05 | 33.45 | 33.85 | 33.75 |
| Animal Protein | 8.46 | 5.89 | 5.89 | 5.89 | 5.89 | 0.50 |
| Grain By Products | 4.00 | 4.00 | 4.00 | 4.00 | 4.00 | 3.00 |
| Animal Fat | 3.15 | 3.15 | 3.20 | 3.30 | 3.40 | 4.20 |
| Dextrose | 2.50 | 2.50 | 2.50 | 2.50 | 2.50 | — |
| Other | 5.33 | 5.51 | 5.50 | 5.49 | 5.48 | 4.83 |
| Roughage | — | — | — | — | — | 2.50 |
| Maltodextrin DE18 | — | — | 2.00 | 4.00 | 6.00 | — |
| Total | 100.00 | 100.00 | 100.00 | 100.00 | 100.00 | 100.00 |
| Calculated Nutrient Analysis | | | | | | |
| Protein, % | 22.01 | 22.00 | 22.00 | 22.00 | 22.01 | 21.00 |
| Fat; Crude, % | 5.28 | 5.27 | 5.25 | 5.27 | 5.30 | 6.29 |
| Dry Matter, % | 89.61 | 89.43 | 89.57 | 89.71 | 89.86 | 89.10 |
| Calcium, % | 0.96 | 0.96 | 0.97 | 0.97 | 0.97 | 0.91 |
| Phosphorus, % | 0.74 | 0.73 | 0.73 | 0.73 | 0.72 | 0.71 |
| Lysine, % | 1.40 | 1.40 | 1.40 | 1.40 | 1.40 | 1.30 |

A total of 140 pigs (PIC, C22×327) with an initial weight of 4.62 kilograms were used to assess the ability of maltodextrin with a dextrose equivalent of 18 to be an energy source. The pigs were allotted to one of five treatments based on their initial weight.

There were 4 phases (stages) with 6, 7, 14 and 15 days, respectively. In the phases with 6 and 7 days, the pigs were fed Momentum 10-15 type diets, and in the phase with 15 days, the pigs were fed a meal diet using the MOMENTUM brand feeding program 25-50 formulation. The diets were offered in pellet form in the first 13 days, and in meal form in the rest of the phases. The pigs were obtained from a commercial entity and transported for four hours before being fed the compositions of this example at weaning.

Results from this example are presented in Table 6. Compared with pigs fed negative control diets, pigs fed the positive control diets had similar daily gain and similar feed intake (P>0.10) throughout this example. At the end of the time period of this example, pigs fed the positive control and negative control diets had similar body weights, 54.82 lbs versus 54.80 lbs, respectively. The pigs fed the positive control diets had better feed efficiency for cumulative phases 1-3 (P<0.05) and overall (P<0.10). Increasing dietary maltodextrin linearly decreased feed intake in all individual and cumulative phases (P<0.05 or 0.10), except phase 2. The maltodextrin tended to linearly decrease daily gain in phase 3 (P=0.161), phase 4 (0.097), and overall (P=0.197). Increasing maltodextrin linearly improved feed efficiency in phase 2 (P=0.06) and all cumulative phases (P<0.06). Increasing dietary maltodextrin had quadratic effects on daily gain and feed efficiency in phase 3 (P<0.08) and cumulative phases 1-3 (P<0.11).

Compared with pigs fed negative control diets, pigs fed 2% maltodextrin grew faster in phase 3 (P<0.10) and had better feed efficiency in phase 2 (P<0.10), cumulative phases 1-2 (P<0.10), and cumulative phases 1-3 and 1-4 (P<0.05). Final weights for pigs fed 2% maltodextrin was almost 2.0 lbs heavier than pigs fed negative control and positive control diets, and 3 lbs heavier than pigs fed 4% or 6% maltodextrin.

TABLE 6
Evaluation of Maltodextrin DE18 as an Energy (Lactose)
Source in Swine Nursery Diets Performance Data.

| | Treatment No. | | | | | | | | | | | |
|---|---|---|---|---|---|---|---|---|---|---|---|---|
| | 1 | 2 | 3 | 4 | 5 | | | | | | | |
| | Treatment Description | | | | | | | | | | | |
| | Pos. | Neg. | | | | | | | | | | |
| | Control | Control | NC+ | NC+ | NC+ | | | P Values | | | | |
| | Maltodextrin DE18, % | | | | | | | | Maltodextrin DE18 | | | Pair-wise |
| | — | — | 2 | 4 | 6 | Mean | SE | Program | Linear | Quadratic | Cubic | Comparison¹ |
| No. pens/trt | 6 | 6 | 6 | 6 | 6 | | | | | | | |
| No. pigs/trt | 24 | 24(1)* | 24 | 24 | 24(1) | | | | | | | |
| Weight, kg | | | | | | | | | | | | |
| Initial | 4.54 | 4.60 | 4.61 | 4.67 | 4.67 | 4.62 | 0.13 | | | | | |
| Stage 1, 6 d | 6.05 | 6.09 | 6.08 | 6.07 | 6.00 | 6.06 | 0.09 | 0.953 | 0.509 | 0.695 | 0.876 | — |
| Stage 2, 7 d | 7.93 | 8.03 | 8.25 | 8.04 | 8.08 | 8.07 | 0.16 | 0.718 | 0.925 | 0.580 | 0.361 | — |
| Stage 3, 14 d | 13.96 | 13.85 | 14.58 | 13.91 | 13.62 | 13.98 | 0.39 | 0.509 | 0.437 | 0.203 | 0.318 | i |
| Stage 4, 15 d | 24.87 | 24.86 | 25.74 | 24.38 | 24.22 | 24.81 | 0.65 | 0.519 | 0.273 | 0.433 | 0.247 | — |
| Daily Gain, kg | | | | | | | | | | | | |
| Stage 1, 6 d | 0.251 | 0.248 | 0.245 | 0.235 | 0.223 | 0.240 | 0.017 | 0.754 | 0.259 | 0.784 | 0.943 | — |
| Stage 2, 7 d | 0.269 | 0.278 | 0.310 | 0.281 | 0.297 | 0.287 | 0.017 | 0.430 | 0.720 | 0.622 | 0.160 | b |
| Stage 3, 14 d | 0.431 | 0.411 | 0.452 | 0.419 | 0.387 | 0.420 | 0.017 | 0.097 | 0.161 | 0.033 | 0.326 | del |
| Stage 4, 15 d | 0.728 | 0.734 | 0.744 | 0.698 | 0.707 | 0.722 | 0.017 | 0.276 | 0.097 | 0.975 | 0.139 | h |
| Overall, S1-2 | 0.260 | 0.264 | 0.280 | 0.260 | 0.262 | 0.265 | 0.011 | 0.659 | 0.611 | 0.548 | 0.227 | — |
| Overall, S1-3 | 0.349 | 0.340 | 0.369 | 0.342 | 0.327 | 0.345 | 0.013 | 0.273 | 0.269 | 0.104 | 0.271 | l |
| Overall, S1-4 | 0.484 | 0.477 | 0.503 | 0.469 | 0.459 | 0.478 | 0.015 | 0.306 | 0.197 | 0.220 | 0.219 | l |
| Feed Intake, | | | | | | | | | | | | |
| kg/d | | | | | | | | | | | | |
| Stage 1, 6 d | 0.214 | 0.224 | 0.211 | 0.198 | 0.188 | 0.207 | 0.009 | 0.087 | 0.008 | 0.890 | 0.975 | dfGi |
| Stage 2, 7 d | 0.350 | 0.361 | 0.372 | 0.348 | 0.351 | 0.356 | 0.013 | 0.665 | 0.360 | 0.730 | 0.306 | — |
| Stage 3, 14 d | 0.558 | 0.580 | 0.601 | 0.548 | 0.522 | 0.562 | 0.026 | 0.271 | 0.061 | 0.368 | 0.393 | l |
| Stage 4, 15 d | 1.028 | 1.070 | 1.028 | 1.038 | 0.953 | 1.024 | 0.043 | 0.426 | 0.089 | 0.618 | 0.454 | g |
| Overall, S1-2 | 0.287 | 0.297 | 0.297 | 0.279 | 0.276 | 0.287 | 0.010 | 0.434 | 0.079 | 0.859 | 0.478 | — |
| Overall, S1-3 | 0.428 | 0.443 | 0.455 | 0.419 | 0.402 | 0.429 | 0.016 | 0.211 | 0.040 | 0.399 | 0.368 | gl |
| Overall, S1-4 | 0.642 | 0.661 | 0.660 | 0.640 | 0.594 | 0.639 | 0.022 | 0.247 | 0.039 | 0.327 | 0.942 | Gi |
| Feed/Gain | | | | | | | | | | | | |
| Stage 1, 6 d | 0.856 | 0.904 | 0.860 | 0.851 | 0.850 | 0.864 | 0.035 | 0.803 | 0.285 | 0.544 | 0.867 | — |
| Stage 2, 7 d | 1.307 | 1.301 | 1.207 | 1.244 | 1.189 | 1.250 | 0.035 | 0.067 | 0.061 | 0.585 | 0.166 | BDeG |
| Stage 3, 14 d | 1.299 | 1.412 | 1.331 | 1.305 | 1.353 | 1.340 | 0.035 | 0.172 | 0.204 | 0.076 | 0.903 | AF |
| Stage 4, 15 d | 1.412 | 1.459 | 1.380 | 1.498 | 1.349 | 1.419 | 0.035 | 0.028 | 0.182 | 0.326 | 0.004 | cGHJ |
| Overall, S1-2 | 1.103 | 1.128 | 1.066 | 1.076 | 1.054 | 1.085 | 0.023 | 0.197 | 0.055 | 0.395 | 0.320 | eG |
| Overall, S1-3 | 1.228 | 1.305 | 1.234 | 1.222 | 1.234 | 1.244 | 0.022 | 0.093 | 0.037 | 0.078 | 0.723 | AEFG |
| Overall, S1-4 | 1.326 | 1.387 | 1.311 | 1.367 | 1.295 | 1.337 | 0.024 | 0.074 | 0.059 | 0.935 | 0.026 | aEGJ |

*Numbers in parentheses are numbers of pigs removed during the trial.
¹A lower case letter refers to .05 < P < .10 and an upper case letter refers to P < .05.
A or a = Trt 1 vs. Trt
B or b = Trt 1 vs. Trt
C or c = Trt 1 vs. Trt
D or d = Trt 1 vs. Trt 5
E or e = Trt 2 vs. Trt 3
F or f = Trt 2 vs. Trt 4
G or g = Trt 2 vs. Trt 5
H or h = Trt 3 vs. Trt 4
I or i = Trt 3 vs. Trt 5
J or j = Trt 4 vs. Trt 5

The data from this example suggests that increasing dietary lactose by 25% did not improve performance. The data further suggests that increasing dietary maltodextrin was beneficial to nursery pigs which appear to be due to improved feed efficiency. The data also indicates that pigs fed 2% maltodextrin were at least 1.9 lbs heavier than those fed 0, 4 or 6% maltodextrin or the positive control diets. Thus, based on the results of this example, 2% maltodextrin was optimal and it appears that maltodextrin serves as a highly digestible energy source when included at proper levels in the diet.

### Example 3

Feed compositions having the ingredients listed in Tables 7 and 8 were prepared. Table 7 lists four dietary treatments including a positive control (PC), negative control (NC), a negative control with 4.3% maltodextrin, and a negative control with 8.6% maltodextrin. The maltodextrin in this example had a dextrose equivalent of 10. The positive control diets had 12.5% and 7.5% lactose in phase 1 and phase 2-3, respectively, and the negative control diets had 4.5% lactose and 1.5% lactose, respectively.

Table 8 lists four dietary treatments for 15-25 lb body weight (phase 2-3) and includes a positive control (PC), a negative control (NC), a negative control with 3.2% maltodextrin and a negative control with 6.4% maltodextrin. The maltodextrin in this example had a dextrose equivalent of 10. Dietary energy, protein, lysine (amino acid ratios), major minerals and vitamins were approximately equal across each treatment within each phase.

TABLE 7
Composition of Stage 1 Diets.

| | Treatment | | | |
|---|---|---|---|---|
| | 1 | 2 | 3 | 4 |
| | Treatment Description | | | |
| | Positive | Negative | NC + | NC + |
| | Control | Control | 4.3% DE10 | 8.6% DE10 |
| Ingredients, % | | | | |
| Grain products | 42.28 | 51.33 | 47.03 | 43.00 |
| Plant proteins | 23.85 | 25.00 | 25.00 | 25.00 |
| Animal proteins | 25.63 | 14.67 | 14.67 | 14.67 |
| Animal fat | 3.60 | 3.65 | 3.55 | 3.25 |
| Others | 4.64 | 4.35 | 5.45 | 5.48 |
| Maltodextrin DE10 | — | — | 4.30 | 8.60 |
| Total | 100.00 | 100.00 | 100.00 | 100.00 |
| Calculated Nutrient | | | | |
| Analysis | | | | |
| Dry Matter, % | 90.63 | 89.91 | 90.19 | 90.44 |
| Protein, % | 23.61 | 23.62 | 23.33 | 23.06 |
| Fat; Crude, % | 6.76 | 6.79 | 6.54 | 6.13 |
| Calcium, % | 1.05 | 1.06 | 1.07 | 1.05 |
| Phosphorus, % | 0.75 | 0.76 | 0.76 | 0.76 |
| Lysine, % | 1.50 | 1.50 | 1.50 | 1.50 |

TABLE 8
Composition of Stage 2 to 4 Diets.

| | Treatment | | | | |
|---|---|---|---|---|---|
| | 1 | 2 | 3 | 4 | 1-4 |
| | Treatment Description | | | | |
| | Positive | Negative | NC + | NC + | |
| | Control | Control | 3.2% DE10 | 6.4% DE10 | Common |
| | Stage | | | | |
| | 2 & 3 | 2 & 3 | 2 & 3 | 2 & 3 | 4 |
| Ingredients, % | | | | | |
| Grain Products | 44.67 | 51.41 | 47.67 | 43.97 | 48.40 |
| Plant Protein | 31.55 | 32.40 | 33.00 | 33.60 | 34.50 |
| Animal Protein | 11.78 | 3.56 | 3.56 | 3.56 | 0.50 |
| Grain By Products | 4.00 | 4.00 | 4.00 | 4.00 | 3.00 |
| Animal Fat | 3.00 | 3.05 | 3.00 | 2.90 | 4.15 |
| Other | 5.00 | 5.58 | 5.57 | 5.57 | 4.85 |
| Roughage | — | — | — | — | 4.60 |
| Maltodextrin DE10 | — | — | 3.20 | 6.40 | — |
| Total | 100.00 | 100.00 | 100.00 | 100.00 | 100.00 |
| Calculated Nutrient Analysis | | | | | |
| Dry Matter, % | 89.78 | 89.25 | 89.46 | 89.67 | 89.85 |
| Protein, % | 22.00 | 22.00 | 22.00 | 22.00 | 21.00 |
| Fat; Crude, % | 5.26 | 5.29 | 5.13 | 4.92 | 6.25 |
| Calcium, % | 0.96 | 0.97 | 0.97 | 0.97 | 0.91 |
| Phosphorus, % | 0.72 | 0.74 | 0.74 | 0.73 | 0.71 |
| Lysine, % | 1.40 | 1.40 | 1.40 | 1.40 | 1.30 |

A total of 120 pigs (Monsanto Choice Genetics, EBX×GP37) with an initial weight of 5.2 kilograms were used to assess the performance of maltodextrin with a dextrose equivalent of 10 on nursery pigs. The pigs were allotted to one of four dietary treatments based on their initial weight. This example had four phases with 7, 6, 8 and 11 days, respectively. The 3-phase example diets were fed for 7, 14 and 11 days. In the last 11 day phase, all pigs were fed a common meal diet that did not include maltodextrin or dextrose. The diets were offered in pellet form for the 7 day phase, and the rest of the phases provided the diets in meal form. The pigs were transported for four hours before being fed the compositions of this example at weaning. The results of this example are presented in Table 9.

TABLE 9
Evaluation of Maltodextrins as an Energy (Lactose)
Source in Swine Nursery Diets Performance Data.

| | Treatment No. | | | | | | | |
|---|---|---|---|---|---|---|---|---|
| | 1 | 2 | 3 | 4 | | | | |
| | Trt - Control | | | | | | | |
| | Positive | Negative | Negative | Negative | | | | |
| | % Added DE10 | | | | | P Values | | |
| | Stage 1/2 & 3 | | | | | | DE10 | DE10 |
| | — | — | 4.3/3.2 | 8.6/6.4 | SE | Program | Linear | Quadratic |
| No. pens/trt | 6 | 6 | 6 | 6 | | | | |
| No. pigs/trt | 30 | 30(1)* | 30 | 30 | | | | |
| Weight, kg | | | | | | | | |
| Initial | 5.16 | 5.17 | 5.17 | 5.16 | 0.45 | | | |
| Stage 1, 7 d | 6.75 | 6.79 | 6.75 | 6.75 | 0.09 | 0.153 | 0.741 | 0.860 |
| Stage 2, 6 d | 8.93 | 8.79 | 8.94 | 8.84 | 0.15 | 0.022 | 0.789 | 0.485 |
| Stage 3, 8 d | 13.02 | 13.09 | 13.14 | 12.78 | 0.20 | 0.021 | 0.285 | 0.404 |
| Stage 4, 11 d | 20.82 | 20.53 | 21.21 | 20.53 | 0.34 | 0.109 | 0.997 | 0.111 |
| Daily Gain, kg | | | | | | | | |
| Stage 1, 7 d | 0.226 | 0.232 | 0.226 | 0.226 | 0.016 | 0.342 | 0.821 | 0.868 |
| Stage 2, 6 d | 0.364 | 0.333 | 0.366 | 0.350 | 0.016 | 0.025 | 0.473 | 0.220 |
| Stage 3, 8 d | 0.511 | 0.521 | 0.524 | 0.492 | 0.016 | 0.253 | 0.211 | 0.367 |
| Stage 4, 11 d | 0.709 | 0.677 | 0.734 | 0.705 | 0.016 | 0.168 | 0.226 | 0.033 |
| Overall, S1-2 | 0.290 | 0.279 | 0.291 | 0.283 | 0.012 | 0.025 | 0.767 | 0.501 |
| Overall, S1-3 | 0.374 | 0.369 | 0.380 | 0.363 | 0.011 | 0.023 | 0.705 | 0.304 |
| Overall, S1-4 | 0.489 | 0.473 | 0.502 | 0.480 | 0.011 | 0.059 | 0.636 | 0.087 |
| Feed Intake, kg/d | | | | | | | | |
| Stage 1, 7 d | 0.221 | 0.223 | 0.224 | 0.218 | 0.010 | 0.175 | 0.712 | 0.759 |
| Stage 2, 6 d | 0.448 | 0.438 | 0.455 | 0.442 | 0.015 | 0.126 | 0.832 | 0.403 |
| Stage 3, 8 d | 0.628 | 0.625 | 0.650 | 0.610 | 0.017 | 0.280 | 0.537 | 0.128 |
| Stage 4, 11 d | 0.986 | 0.963 | 0.992 | 0.949 | 0.026 | 0.476 | 0.701 | 0.257 |
| Overall, S1-2 | 0.326 | 0.322 | 0.331 | 0.321 | 0.012 | 0.158 | 0.959 | 0.546 |
| Overall, S1-3 | 0.441 | 0.435 | 0.452 | 0.431 | 0.013 | 0.149 | 0.834 | 0.248 |
| Overall, S1-4 | 0.628 | 0.614 | 0.638 | 0.609 | 0.015 | 0.122 | 0.824 | 0.160 |
| Feed/Gain | | | | | | | | |
| Stage 1, 7 d | 0.978 | 0.968 | 1.000 | 0.962 | 0.052 | 0.739 | 0.934 | 0.586 |
| Stage 2, 6 d | 1.237 | 1.319 | 1.248 | 1.268 | 0.053 | 0.105 | 0.502 | 0.487 |
| Stage 3, 8 d | 1.229 | 1.198 | 1.249 | 1.246 | 0.032 | 0.647 | 0.305 | 0.502 |
| Stage 4, 11 d | 1.390 | 1.423 | 1.350 | 1.349 | 0.026 | 0.311 | 0.056 | 0.278 |
| Overall, S1-2 | 1.125 | 1.159 | 1.140 | 1.135 | 0.028 | 0.228 | 0.547 | 0.834 |
| Overall, S1-3 | 1.178 | 1.177 | 1.196 | 1.190 | 0.022 | 0.253 | 0.674 | 0.644 |
| Overall, S1-4 | 1.283 | 1.295 | 1.272 | 1.269 | 0.016 | 0.598 | 0.262 | 0.629 |

*Numbers in parentheses are numbers of pigs removed during the trial.

Compared with pigs fed negative control diets, pigs fed the positive control diets had similar daily gain, similar feed intake and similar feed efficiency (P>0.10) throughout the time of this example. At the end of phase 3 (i.e., before a common non-lactose diet was fed in phase 4), pigs fed the positive and negative control diets had similar body weights, 28.71 lbs versus 28.85 lbs, respectively. The increasing amounts of maltodextrin in this example had a quadratic effect on daily gain in phase 4 (P=0.03) and cumulative phases 1-4 (P=0.09). In this example, the maltodextrin tended to linearly improve feed efficiency in phase 4 (P=0.06). The maltodextrin also had a quadratic effect (P=0.11) on final body weight, where pigs that were fed low levels of maltodextrin weighed more (about 0.68 kg/pig) than pigs fed zero or high levels of maltodextrin. It appears that the performance improvement from pigs consuming maltodextrin occurred when the pigs were on the common diet in phase 4, suggesting a possible carryover effect from consuming the maltodextrin.

One reason that pigs may have had a reduced performance on the high maltodextrin diet may be a result of the poor pellet quality in phase 1 since it was difficult to establish an ideal flow and steam rate in the pelleting process for diets containing the 8.6% maltodextrin. Also, the pellet die was plugged many times during the pelleting of the high maltodextrin formulation. Thus, in a process for producing maltodextrin feeds, it may be advantageous to use no more than 5% maltodextrin in a swine nursery diet when conventional pelleting procedures are employed.

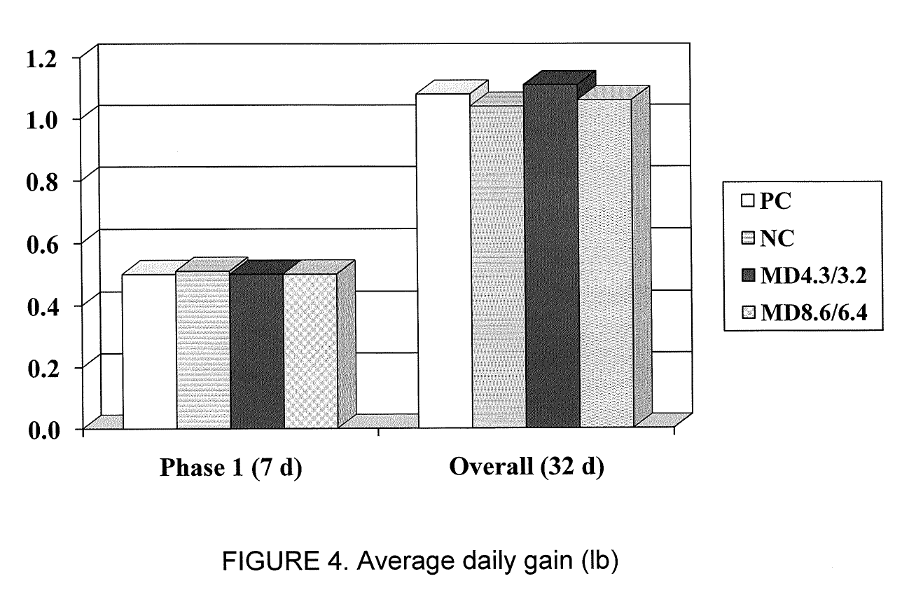

The effect of maltodextrin levels on average daily gain (ADG) of pigs fed diets containing no dextrose are presented in FIG. 4. In FIG. 4, 6 pens and 30 pigs per treatment were used. The weaning weight was 11.4 lbs, where phases 1, 2 and 3 correlated to 7, 14 and 11 days, respectively. The positive control diets had 8% and 6% units higher lactose than the negative control diets in phases 1 and 2. The overall average daily gain, shown in pounds, for FIG. 4 indicates a quadratic effect of maltodextrin.

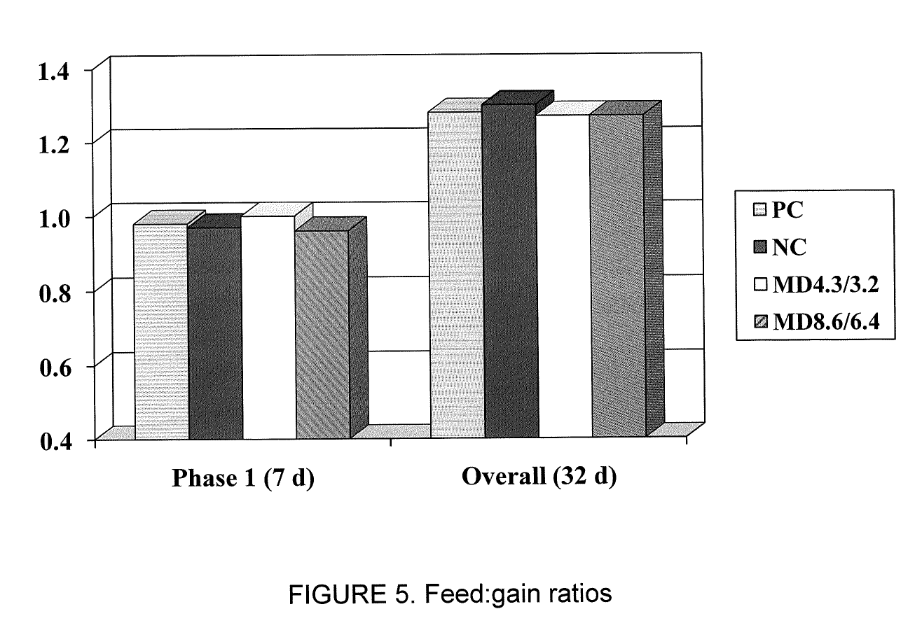

The effect of maltodextrin levels on feed/gain of pigs fed diets containing no dextrose is shown in FIG. 5. In FIG. 5, 6 pens and 30 pigs per treatment were used. The weaning weight was 11.4 lbs, where phases 1, 2 and 3 correlated to 7, 14 and 11 days, respectively. The positive control diets had 8% and 6% units higher lactose than the negative control diets in phases 1 and 2. There was no statistical difference (P>0.10) on the feed/gain in this example.

The data from this example suggests that decreasing lactose (i.e., 8% units in Momentum 10-15 type diets and 6% units in Momentum 15-25 type diets) did not compromise nursery performance. Further, the addition of low levels of maltodextrin with a dextrose equivalent of 10 numerically improved overall daily gain and feed efficiency. At the end of the 32 day time period for this example, the pigs fed low levels of maltodextrin weighed 0.68 kg more than pigs fed the negative control diets.

### Example 4

A total of 130 pigs (PIC C22×327; initial weight: 5.52 kg lb) were used to determine the effectiveness of animal feed compositions of the present invention in partially replacing lactose in nursery diets. Pigs were randomly allotted to one of four dietary treatments based on their initial weight. There were eight pens and 32 or 33 pigs per treatment. Treatment 1 was the control diets, with lactose coming from whey only; treatments 2 to 4 used maltodextrin feed compositions of the present invention to replace dietary lactose by 25%, 50%, and 75%, respectively.

The maltodextrin feed compositions of this example contain maltodextrin, dextrose, corn syrup solid, sucrose, dextrin and starch and contains 89.2% lactose equivalent value. When the animal feed compositions of this example were used to replace lactose at different inclusion levels, total dietary lactose equivalent values remained the same across the four treatments within each phase. Control diets contained 16% lactose in phases 1 and 2 (the first 10 days postweaning) and 10.7% lactose in phase 3 (the next 13 days). Control formulas were formulated by modifying MOMENTUM brand feeding program 10-15 and 15-25 formulas, as presented in Tables 10 and 11. Diets were formulated to have equal levels of metabolism energy, lactose equivalent value, digestible lysine (minimum amino acid ratios), calcium, available phosphorus, and other major nutrients. The study in this example had 3 phases with 6, 4, and 13 days, respectively. Diets were offered in pellet form in the first 10 days and meal form thereafter. The pigs were obtained from a commercial entity and transported for four hours before being fed the compositions of this example at weaning.

TABLE 10
Composition of Stage 1 and 2 Diets.

| | Treatment | | | |
|---|---|---|---|---|
| | 1 | 2 | 3 | 4 |
| | Whey Replacement | | | |
| | by Maltodextrin | | | |
| | composition, % | | | |
| | 0 | 25 | 50 | 75 |
| Ingredients, % | | | | |
| Grain products | 28.42 | 28.18 | 28.48 | 29.42 |
| Plant proteins | 22.20 | 23.00 | 23.00 | 23.00 |
| Animal proteins | 28.42 | 23.38 | 18.79 | 14.19 |
| Grain byproducts | 12.00 | 12.00 | 12.00 | 12.00 |
| Animal fats | 3.95 | 3.70 | 3.30 | 2.65 |
| Others | 5.01 | 5.24 | 5.43 | 5.24 |
| Maltodextrin composition | 0.00 | 4.50 | 9.00 | 13.50 |
| Total | 100.00 | 100.00 | 100.00 | 100.00 |
| Calculated Nutrient Analysis | | | | |
| Dry Matter, % | 90.92 | 90.95 | 90.98 | 90.94 |
| Protein, % | 22.50 | 22.52 | 22.49 | 22.51 |
| Fat; Crude, % | 6.50 | 6.26 | 5.92 | 5.35 |
| Calcium, % | 1.05 | 1.05 | 1.06 | 1.01 |
| Phosphorus, % | 0.75 | 0.75 | 0.75 | 0.75 |
| Lysine, % | 1.60 | 1.60 | 1.59 | 1.59 |

TABLE 11
Composition of Stage 3 diets.

| | Treatment | | | |
|---|---|---|---|---|
| | 1 | 2 | 3 | 4 |
| | Whey Replacement | | | |
| | by Present invention, % | | | |
| | 0 | 25 | 50 | 75 |
| Ingredients, % | | | | |
| Grain products | 44.16 | 44.17 | 44.01 | 44.14 |
| Plant proteins | 28.05 | 28.90 | 29.00 | 29.00 |
| Animal proteins | 15.66 | 12.00 | 8.94 | 5.93 |
| Grain byproducts | 4.00 | 4.00 | 4.00 | 4.00 |
| Animal fats | 3.25 | 3.00 | 2.90 | 2.65 |
| Others | 4.88 | 4.93 | 5.15 | 5.28 |
| Maltodextrin composition | 0.00 | 3.00 | 6.00 | 9.00 |
| Total | 100.00 | 100.00 | 100.00 | 100.00 |
| Calculated Nutrient Analysis | | | | |
| Dry Matter, % | 89.82 | 89.80 | 89.85 | 89.88 |
| Protein, % | 20.51 | 20.51 | 20.51 | 20.52 |
| Fat; Crude, % | 5.28 | 5.01 | 4.94 | 4.73 |
| Calcium, % | 0.97 | 0.96 | 0.96 | 0.98 |
| Phosphorus, % | 0.71 | 0.70 | 0.70 | 0.71 |
| Lysine, % | 1.39 | 1.39 | 1.39 | 1.38 |

Performance data is presented in Table 12. Increasing dietary substitution of maltodextrin feed compositions of the present invention for whey did not have significant effects (P>0.10) on daily gain or feed intake during each individual or cumulative phases, although there were some numerical improvements. However, increasing substitution tended to linearly improve feed efficiency in phase 1 (P=0.106) and had quadratic (P=0.065) and cubic (P=0.042) effects on overall feed efficiency. The latter finding suggested that 25% replacement of lactose by maltodextrin feed compositions of the present invention was the optimal diet in this study. This was further supported by the results that pigs fed 25% replacement had better feed efficiency than pigs fed control (P<0.05) and pigs fed 50% or 75% replacement (P<0.10). At 25% replacement rate, maltodextrin feed compositions of the present invention inclusion level was 4.5% in the first 2 phases and 3% in phase 3, which provided effective amount of maltodextrin, dextrose and other feed ingredients.

TABLE 12
Evaluation of animal feed composition of this example
substitution for lactose in nursery diets, Stage 1-3 Performance Data.

| | Treatment No. | | | | | | | | | | |
|---|---|---|---|---|---|---|---|---|---|---|---|
| | 1 | 2 | 3 | 4 | | | | | | | |
| | Whey Replacement | | | | | | P Values | | | | |
| | by Energy Burst, % | | | | | | | Burst | Burst | Burst | Pair-wise |
| | 0 | 25 | 50 | 75 | Mean | SE | Program | Linear | Quadratic | Cubic | Comparison¹ |
| No. pens/trt | 8 | 8 | 8 | 8 | | | | | | | |
| No. pigs/trt | 33 | 32 | 32 | 33 | | | | | | | |
| Weight, kg | | | | | | | | | | | |
| Initial | 5.59 | 5.50 | 5.50 | 5.49 | 5.52 | 0.22 | | | | | |
| Stage 1, 6 d | 6.01 | 6.06 | 5.90 | 5.98 | 5.99 | 0.09 | 0.655 | 0.556 | 0.881 | 0.271 | — |
| Stage 2, 4 d | 7.05 | 7.18 | 6.95 | 7.01 | 7.05 | 0.12 | 0.547 | 0.492 | 0.783 | 0.215 | — |
| Stage 3, 13 d | 12.32 | 12.84 | 12.75 | 12.64 | 12.64 | 0.29 | 0.625 | 0.508 | 0.299 | 0.657 | — |
| Daily Gain, kg | | | | | | | | | | | |
| Stage 1, 6 d | 0.071 | 0.094 | 0.067 | 0.081 | 0.078 | 0.018 | 0.712 | 0.940 | 0.795 | 0.258 | — |
| Stage 2, 4 d | 0.261 | 0.279 | 0.261 | 0.257 | 0.264 | 0.018 | 0.797 | 0.695 | 0.520 | 0.507 | — |
| Stage 3, 13 d | 0.405 | 0.436 | 0.446 | 0.434 | 0.430 | 0.018 | 0.397 | 0.227 | 0.222 | 0.955 | b |
| Overall, S1-2 | 0.147 | 0.168 | 0.145 | 0.151 | 0.153 | 0.014 | 0.645 | 0.890 | 0.610 | 0.248 | — |
| Overall, S1-3 | 0.293 | 0.319 | 0.315 | 0.311 | 0.309 | 0.014 | 0.539 | 0.416 | 0.268 | 0.627 | — |
| Feed Intake, | | | | | | | | | | | |
| kg/d | | | | | | | | | | | |
| Stage 1, 6 d | 0.126 | 0.128 | 0.129 | 0.134 | 0.129 | 0.013 | 0.981 | 0.698 | 0.928 | 0.918 | — |
| Stage 2, 4 d | 0.265 | 0.270 | 0.253 | 0.264 | 0.263 | 0.015 | 0.884 | 0.771 | 0.826 | 0.477 | — |
| Stage 3, 13 d | 0.539 | 0.555 | 0.581 | 0.568 | 0.561 | 0.022 | 0.581 | 0.263 | 0.514 | 0.618 | — |
| Overall, S1-2 | 0.182 | 0.185 | 0.179 | 0.186 | 0.183 | 0.013 | 0.979 | 0.917 | 0.877 | 0.700 | — |
| Overall, S1-3 | 0.384 | 0.394 | 0.406 | 0.402 | 0.397 | 0.016 | 0.777 | 0.370 | 0.654 | 0.804 | — |
| Feed/Gain | | | | | | | | | | | |
| Stage 1, 6 d | 1.516 | 1.331 | 1.676 | 1.775 | 1.574 | 0.149 | 0.175 | 0.106 | 0.351 | 0.269 | E |
| Stage 2, 4 d | 1.042 | 0.980 | 0.989 | 1.045 | 1.014 | 0.068 | 0.855 | 0.956 | 0.391 | 0.941 | — |
| Stage 3, 13 d | 1.331 | 1.279 | 1.312 | 1.314 | 1.309 | 0.022 | 0.431 | 0.856 | 0.238 | 0.255 | — |
| Overall, S1-2 | 1.388 | 1.119 | 1.241 | 1.246 | 1.248 | 0.102 | 0.342 | 0.511 | 0.190 | 0.276 | a |
| Overall, S1-3 | 1.315 | 1.236 | 1.295 | 1.295 | 1.285 | 0.020 | 0.062 | 0.991 | 0.065 | 0.042 | Ade |

¹A lower case letter refers to .05 < P < .10 and an upper case letter refers to P < .05.
A or a = Trt 1 vs. Trt 2
B or b = Trt 1 vs. Trt 3
C or c = Trt 1 vs. Trt 4
D or d = Trt 2 vs. Trt 3
E or e = Trt 2 vs. Trt 4
F or f = Trt 3 vs. Trt 4

Data from this study suggested that: 1) maltodextrin feed compositions of the present invention can be used to replace lactose up to 75% in nursery diets without compromising nursery performance and may have feed cost savings when lactose is expensive; 2) when maltodextrin feed compositions of the present invention replaced 25% lactose, it improved overall feed efficiency, in other words, the optimal maltodextrin compositions of the present invention inclusion levels were 4.5% in the first 10 days postweaning and 3% in the next two weeks; 3) maltodextrin feed compositions of the present invention contain maltodextrin, dextrose, corn syrup solid, sucrose, dextrin and starch. At 3% to 4.5% inclusion levels in this study, it provided enough amounts of maltodextrin, dextrose and other feed ingredients that helped to improve feed efficiency of nursery pigs. The improved feed efficiency would help swine producers generate more economic benefits

The present invention has been described with reference to certain exemplary embodiments, compositions and uses thereof. However, it will be recognized by those of ordinary skill in the art that various substitutions, modifications or combinations of any of the exemplary embodiments may be made without departing from the spirit and scope of the invention. Thus, the invention is not limited by the description of the exemplary embodiments, but rather by the appended claims as originally filed.

1. A dry feed composition comprising:
an ingredient selected from the group consisting of maltodextrin, dextrose and a combination thereof; and
a grain product.

2. The dry feed composition of claim 1, further comprising a second ingredient selected from the group consisting of corn syrup solids, starch, dextrins, sucrose and any combinations thereof.

3. The dry feed composition of claim 1, further comprising a compound selected from the group consisting of a protein source, an isolated or purified amino acid, an isolated or purified vitamin, an isolated or purified mineral, corn steep liquor, condensed distiller's solubles, cane molasses, an animal fat, a vegetable oil, a modified starch, a botanical product and combinations of any thereof.

4. The dry feed composition of claim 1, further comprising a lactose source.

5. The dry feed composition of claim 1, 4, wherein the grain product is selected from the group consisting of ground grain, an oilseed meal and a combination thereof.

6. The dry feed composition of claim 1, wherein the maltodextrin has a dextrose equivalent of between 1 and 20.

7. The dry feed composition of claim 1, further comprising a yeast product comprising mannanoligosaccharides, beta-glucan or a combination thereof.

8. The dry feed composition of claim 1, further comprising an acidifier selected from the group consisting of an organic acid, an inorganic acid and combinations thereof.

9. The dry feed composition of claim 1, wherein the ingredient comprises the combination thereof and has a dextrose equivalent of between 5 and 90.

10-11. (canceled)

12. A method, comprising:
feeding an animal feed composition comprising maltodextrin to a monogastric animal such that the monogastric animal receives an amount of the maltodextrin of between 0.001-10% of the monogastric animal's weight per day.

13. The method according to claim 12, wherein the monogastric animal is a pig.

14. The method according to claim 12, wherein the animal feed composition further comprises a grain product.

15. The method according to claim 12, wherein the animal feed composition further comprises a compound selected from the group consisting of a lactose source, dextrose, a modified starch and combinations of any thereof.

16. The method according to claim 12, wherein feeding the animal feed to the monogastric animal comprises offering a dry animal feed.

17. The method according to claim 12, wherein the monogastric animal has been weaned.

18. (canceled)

19. The method according to claim 14, further comprising:
configuring the animal feed composition comprising the maltodextrin as a supplement; and
mixing the supplement with the grain product, thus producing the animal feed composition.

20. A dry feed composition comprising:
maltodextrin;
dextrose;
corn syrup solids;
starch;
dextrin; and
sucrose;
the feed composition comprising at least 15% total sugars.

21. The dry feed composition of claim 20, further comprising a grain product.

22-23. (canceled)

24. The dry feed composition of claim 22, wherein the combination of the dextrose and the maltodextrin is present in the feed composition at between 1-15%.

25. (canceled)

26. The dry feed composition of claim 20, further comprising a lactose source.
